(19) United States
(12) Patent Application Publication
(10) Pub. No.: US 2005/0199082 A1
(43) Pub. Date: Sep. 15, 2005

(54) Steering mechanism assembly for automotive vehicles

(75) Inventors: Renato B. Slave, S. Caetano do Sul (BR); Helcio Domaneschi, Campinas (BR)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/797,974

(22) Filed: Mar. 11, 2004

(51) Int. Cl. F16H 1/04

(52) U.S. Cl. 74/422

(57) ABSTRACT

A steering mechanism for an automotive vehicle is provided, including a pinion, a rack coupled with the pinion, a bushing rotatably receiving the pinion, a rack casing receiving the rack, and a nut for inhibiting rotational movement of the bushing with respect to the rack casing. The bushing is rotatable with respect to the rack casing in order to position a gear section of the pinion in a first position and a second position with respect to the rack. The gear section is located adjacent to an end of the pinion, and the bushing has a first end and a second end adjacent to the end of the pinion. The nut is located adjacent to the first end of the bushing.

### BACKGROUND

The present invention relates generally to a steering mechanism assembly for automotive vehicles, and more particularly to a tubular rack-and-pinion steering mechanism.

An important requirement for automotive steering mechanisms, particularly rack-and-pinion power-assisted mechanisms, is offering stable steering means with precise movement between a pinion and a rack bar. This may be accomplished by mounting the pinion and the rack bar within established limits of tolerances in order to provide proper contact points between the gear section of the pinion and the gear section of the rack bar. Sometimes, however, the tolerances vary out of established limits creating excessive clearances between the respective gear sections. The correction commonly involves additional complicated and time-consuming operations.

Moreover, the pinion gear section and the rack bar gear section are subject to wear over the life of the vehicle. Wear may be caused by axial stresses that urge the rack into a position distant from, and out of proper assembly with, the pinion. Thus, these stresses create a force opposed to maintaining the pinion and rack bar teeth in tight engagement. This wear may create undesirable noise and improper alignment of vehicle relative to the steering wheel.

One current method for correcting improper alignment is to hold the pinion in place with a roller bearing and apply a force to the rack bar with a spring. The spring and the roller bearing combine to urge the pinion and rack bar together into a proper assembled relationship. However, this type of adjustment is mechanically complicated and may be imprecise and costly, both during manufacturing and during servicing of the motor vehicle. Further, the spring may be subject to fatigue.

Improper alignment is also currently corrected by employing a bushing that is selectively rotatable and eccentric with respect to the pinion. The bushing typically includes a locking mechanism that prevents rotation of the bushing when the rack-and-pinion engagement is not being aligned. As the bushing rotates, the bushing adjusts the position of the pinion with respect to the rack. However, the locking mechanism of current assemblies is difficult to access by manufacturers and by service providers.

It is therefore desirous to improve the assembly relationship between the gear sets of the rack-and-pinion steering mechanism with an effective and easily accessible alignment assembly.

### SUMMARY

In overcoming the disadvantages and drawbacks of the known technology, the current invention provides an assembly that improves the manner and ease with which alignment of rack-and-pinion steering mechanisms is effectuated.

One object of the present invention is to provide a rack-and-pinion steering mechanism that enables adjustment of the relative position of the gear sets of the rack-and-pinion assembly. Another object of the present invention is to provide a pinion assembly that allows for periodical adjustment of the pinion-rack relationship so that rotational movement of steering wheel is effectively converted into reciprocal linear movement of the rack.

In one aspect of the invention, a tubular sleeve or bushing, having a top end and a bottom end, is rotatably coupled with a rack casing. Additionally, a pinion is rotatably received within the bushing. The pinion includes a gear section and a shaft section, and the gear section is located adjacent to a bottom end of the bushing. A rack having a gear section is rotatably received within the rack casing. As the bushing is rotated, the position of the pinion with respect to the rack is adjusted.

In another aspect, a nut engages the bushing in order to inhibit the rotational movement of the bushing with respect to the rack casing. The nut is located adjacent to a top end of the bushing. The bushing may be provided with a threaded outer surface, and the nut likewise may be provided with a threaded inner surface. The bushing outer surface and the nut inner surface combine to permit selective engagement between the bushing and the nut and to selectively prevent rotational movement between the bushing and the nut. During periods of adjustment between the rack and the pinion, the nut is loosened or removed from the bushing. After adjustment and prior to operation of the steering mechanism, the nut is tightened to a desired torque in order to inhibit rotational movement of the bushing with respect to the rack casing.

In another aspect of the invention, the bushing is positioned inside a substantially cylindrical pinion housing that is fixed to the rack bar casing. The cylindrical outer surface of the bushing is concentric and coaxial to the pinion housing, and the inner surface of the bushing is eccentric to the pinion housing. As a result, the bushing is capable of adjustably positioning the pinion and rack gear sections with respect to each other by adjusting the eccentricity of the bushing inner surface relative to the pinion housing. The nut may be in press-fit engagement with the pinion housing in order to prevent axial motion between the bushing and the pinion housing. Furthermore, the nut may include a flange that prevents radial movement between the bushing and the pinion housing.

The bushing may be axially supported by a retainer that is located adjacent to one end of the bushing. The retainer may be ring-shaped, and it may be snap-fit into a groove in the bushing. The pinion may be radially supported and coupled with the bushing by first and second bearing assemblies

### BRIEF DESCRIPTION OF THE DRAWINGS

FIG. 1 is a cross-section of a tubular steering mechanism embodying the principles of the present invention;

FIG. 2A is a cross-section of the tubular steering mechanism in FIG. 1 taken generally along the line 2-2 showing the bushing in a first position; and

FIG. 2B is a cross-section of the tubular steering mechanism in FIG. 1 taken generally along the line 2-2 showing the bushing is in a second position.

### DETAILED DESCRIPTION

Referring now to the present invention, it is described with respect to a manual steering mechanism. Those skilled in the art would recognize the present invention as equally applicable to various power assisted rack-and-pinion steering systems, such as electric, electrohydraulic, and hydraulic.

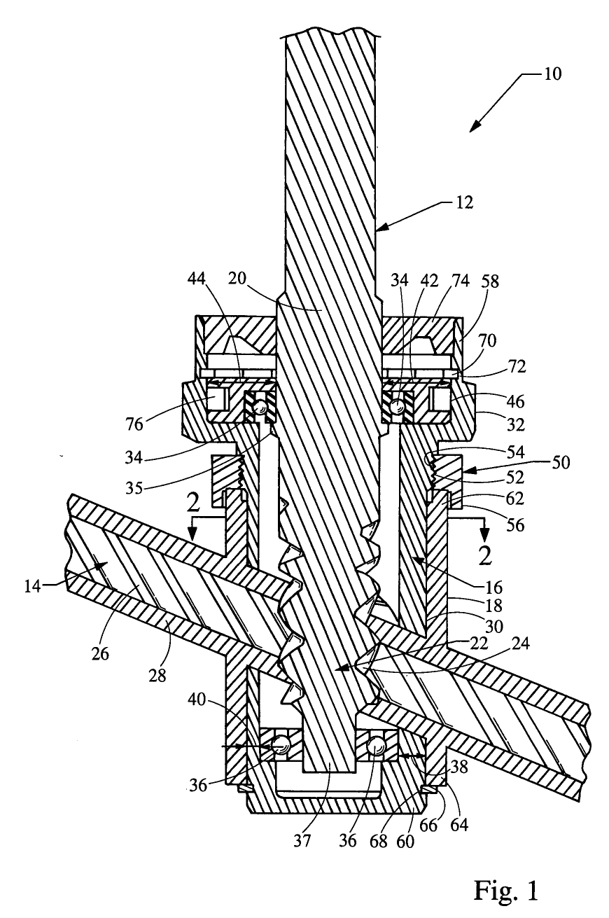

FIG. 1 shows a steering mechanism 10 having a pinion 12 engaged with a rack 14 in order to transform rotational movement of the pinion 12 into transverse movement of the rack 14. The steering mechanism 10 includes a bushing 16 and a pinion housing 18 that cooperate to properly position the pinion 12 with respect to the rack 14.

The pinion 12 is connected via a shaft section 20 to a steering wheel (not shown), or another appropriate steering input mechanism. Therefore, as the operator of a motor vehicle (not shown) turns the steering wheel, the pinion 12 rotates. The pinion 12 also includes gear section 22 supported within the pinion housing 18 mentioned above and including pinion gear teeth 24 which are generally known in the prior art. The pinion 12 may be one unitary piece, as shown in FIG. 1, or it may include multiple connected parts.

The rack 14 includes rack gear teeth 26 that engage with the pinion gear teeth 24 in order to cause translational movement of the rack 14. The rack 14 is received within a rack casing 28, which is substantially cylindrical and includes an opening to permit engagement between the rack 14 and the gear section 24 of the pinion 12. In order to steer the motor vehicle, the rack 14 is further connected to the motor vehicle wheels (not shown) thus controlling the angle of the wheel. The rack casing 28 is fixedly connected to the pinion housing 18 in order to prevent rotational movement between the two respective elements. The rack casing 28 and the pinion housing 18 may be connected by any appropriate mechanism, such as by welding. Alternatively, the rack casing 28 and the pinion housing 18 may be unitarily formed, as shown in FIG. 1.

The bushing 16 rotatably receives the pinion 12, and is used to properly position the pinion 12 with respect to the rack 14, as will be discussed in more detail below. The bushing 16 includes a body section 30 and a collar section 32 and is itself rotatably received within the pinion housing 18. Coupled via top bearings 34 and bottom bearings 36, the pinion rotate with respect to the bushing 16. The pinion 12 is preferably supported at the body section 20 and at a nose section 37 of the pinion. The body section 20 and the nose section 37 are located on opposite sides of the gear section 22. The top bearings 34, which are received by the collar section 32 of the bushing 16, support the shaft section 20 of the pinion 12. The shaft section 20 may include a shoulder 35 to prevent axial motion between the pinion and the top bearings 34. The bottom bearings 36, which are supported by the body section 30 of the bushing 16, contact the nose section 37 of the pinion 12.

In addition to being rotatable with respect to the bushing 16, the radial position of the pinion 12 with respect to the housing 18 is also adjustable. More specifically, opposing sides of the body section 30 have different thicknesses, a first thickness 38 and a second thickness 40. Similarly, the collar section 32 has a first radial distance 42 and a second radial distance 44 measured from a collar inner surface 46 to the pinion 12. The first thickness 38 and the first radial distance 42 are respectively greater than the second thickness 40 and the second radial distance 44. Therefore, as the bushing 16 is rotated with respect to the pinion housing 18, the radial position of the pinion 12 with respect to the pinion housing 18 is adjusted. Accordingly, by rotating the bushing 16, the amount of overlap between the pinion gear teeth 24 and the rack gear teeth 26 is adjusted (the overlap distance), and the torque between the pinion 12 and the rack 14 is likewise adjusted.

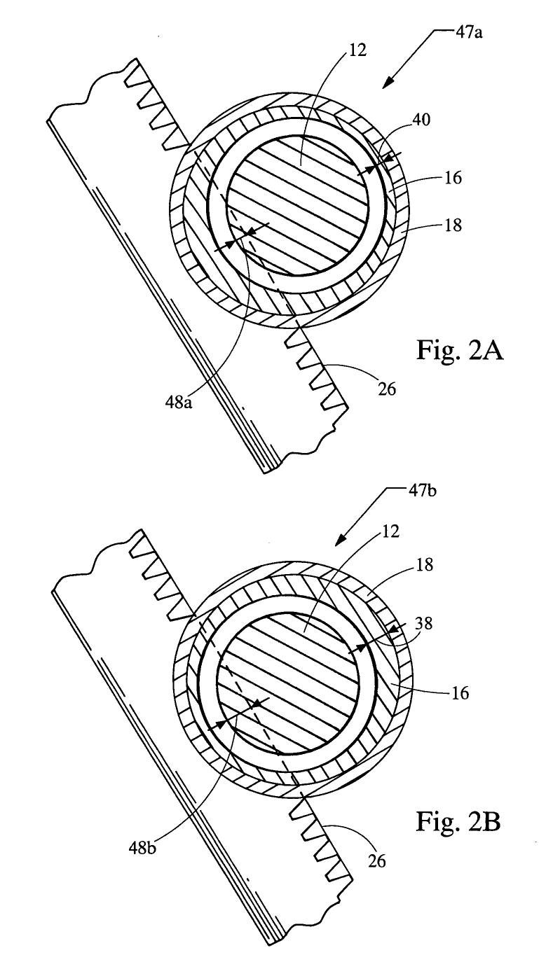

FIGS. 2A and 2B illustrate this rotation of the bushing 16 and show the bushing 16 in a first position 47a and a second position 47b, with respect to the rack casing 28. As shown in FIG. 2A, when the bushing 16 is in a first position 47a, the rack gear teeth 26 and the pinion gear teeth (not shown) have a first overlap distance 48a due to the bushing second thickness 40. Likewise, when the bushing 16 is in a second position 47b, the rack gear teeth 26 (not shown) have a second overlap distance 48b due to the bushing first thickness 38.

The pinion 12 preferably has a range of radial travel of at least 0.8 mm. In other words, the difference between the first overlap distance 48a and the second overlap distance 48b is at least 0.8 mm. However, the present invention may have any appropriate range of radial travel. It may be desirous to limit the range of the angle of rotation of the bushing 16 in order to control the range of radial travel of the pinion 12. The range of the angle of rotation of the bushing 16 is preferably approximately 20″. The steering mechanism 10 may include a structure to limit the angle of rotation of the bushing 16. Alternatively, the bushing 16 may include a section of constant thickness that will not adjust the radial position of the pinion 12.

During operation of the motor vehicle, the bushing 16 is preferably not rotatable with respect to the pinion housing 18. Therefore, a mechanism such as a locking nut 50 preferably inhibits or prevents rotational movement between the bushing 16 and the pinion housing 18 during operation of the motor vehicle. However, the bushing 16 is preferably rotatable with respect to the pinion housing 18 during manufacturing and during servicing of the steering mechanism 10. Therefore, the nut 50 preferably can be loosened or disengaged from the bushing 16 in order to permit rotation between the bushing 16 and the pinion housing 18 as desired.

The nut 50 preferably includes a threaded inner surface 52 that engages a threaded exterior surface 54 of the bushing 16. The nut 50 may also include a lock nut washer (not shown), which may be comprised of any appropriate material, including nylon in order to prevent unintentional loosening of the nut. Alternatively, the nut may be engaged a second locking nut (not shown) in order to prevent unintentional loosening during operation of the motor vehicle. As an alternatively locking mechanism, a flange 56 on the nut 50 may be located radially from the pinion housing 18 to prevent the pinion housing 18 from moving radially with respect to the bushing 16. The perimeter of the nut 50 may additionally be hex-shaped, or another appropriate design, for enabling loosening and tightening the nut 50 via a wrench or other means.

During manufacturing and servicing of the motor vehicle, the nut 50 is typically accessed from the top of the motor vehicle. Therefore, a top end 58 is more accessible than a bottom end 60 of the bushing with the nut 50 being preferably located adjacent to the top end 58. The nut 50 is more preferably located adjacent to a top end 62 of the pinion housing in order to form a press-fit connection with the pinion housing 18.

The pinion housing 18 also preferably includes a means to limit axial movement between the pinion housing 18 and the bushing 16. On such means is a snap ring 66 located near the bottom of the pinion housing end 64. The snap ring 66 is received within a notch 68 extending radially around the outer surface of the bushing 16 and engages the end face of the bottom end 64. The pinion 12 may also include a means to prevent axial movement of the pinion 12 with respect to the bushing 16 and the housing 18, such as a snap ring 70. The snap ring 70 is disposed in a notch 72 formed on the inner surface of the bushing 16.

The steering mechanism 10 is sealed against environmental factors and an input seal 74 located near the top end 58 and preventing external contamination from entering the steering mechanism 10. Additionally, a rubber bushing 76 may be located proximal to the top bearings 34 in order to provide a low friction engagement with the bushing 16, in order to provide the required pinion torque adjustment, and in order to prevent contamination of the steering mechanism 10.

It is therefore intended that the foregoing detailed description be regarded as illustrative rather than limiting, and that it be understood that it is the following claims, including all equivalents, that are intended to define the spirit and scope of this invention.

1. A steering mechanism for an automotive vehicle comprising:
a pinion having a shaft section and a gear section, the gear section being located toward an end of the pinion;
a rack having a gear section coupled with the gear section of the pinion;
a housing enclosing at least portions of the pinion and the rack;
a bushing rotatably received within the housing, the bushing being rotatable to position the pinion with respect to the rack casing in a first position and a second position, the first position locating the gear section of the pinion a first distance relative to the rack, the second position locating the gear section of the pinion a second distance relative to the rack, the bushing defining a first end and a second end, the second end being adjacent the end of the pinion; and
a nut engaged with the bushing to inhibit rotational movement of the bushing with respect to the housing, the nut located adjacent to the first end of the bushing.

2. A steering mechanism as in claim 1, the nut having a threaded inner surface, and the bushing having a threaded outer surface configured to engage the threaded inner surface.

3. A steering mechanism as in claim 2, wherein the pinion is received by the nut.

4. A steering mechanism as in claim 1, wherein the nut is coupled with the housing.

5. A steering mechanism as in claim 4, the nut and the housing are coupled via a press-fit coupling.

6. A steering mechanism as in claim 5, the nut including a flange configured to apply a force to the housing, wherein the force is substantially perpendicular to the pinion outer wall.

7. A steering mechanism as in claim 1, the housing being substantially cylindrical.

8. A steering mechanism as in claim 1, further comprising a retainer located adjacent to the second end of the bushing, the retainer configured to prevent axial movement between the bushing and the housing.

9. A steering mechanism as in claim 8, wherein the retainer is a ring-shaped retainer coupled with the bushing, and the ring-shaped retainer contacts a surface of the housing.

10. A steering mechanism as in claim 1, the bushing having a body section with a first diameter and a collar section with a second diameter larger than the first diameter, the nut positioned adjacent to the collar section.

11. A steering mechanism as in claim 1, wherein the nut is a lock-nut.

12. A steering mechanism as in claim 1, wherein the bushing has an inner wall, an outer wall, and a radius, the inner wall and outer wall defining the bushing thickness, the bushing thickness varying along the bushing radius.

13. A steering mechanism as in claim 1, further including a first bearing assembly rotatably coupling the pinion and the bushing.

14. A steering mechanism as in claim 13, further including a second bearing assembly rotatably coupling the pinion and the bushing, the first bearing assembly located adjacent to the bushing first end, the second bearing assembly located adjacent to the bushing second end.
